(19) United States
(12) Patent Application Publication
(10) Pub. No.: US 2002/0055848 A1
(43) Pub. Date: May 9, 2002

(54) Method and apparatus of business transaction using inherent identification numbers of hardwares

(76) Inventors: Kyung-Sung Jae, Daegu (KR); Jong-Kap Kim, Daegu (KR); Yeong-Hwa Park, Daegu (KR)

Correspondence Address: STAAS & HALSEY LLP, 700 11TH STREET, NW, SUITE 500, WASHINGTON, DC, 20001, US

(21) Appl. No.: 09/766,647

(22) Filed: Jan. 23, 2001

(30) Foreign Application Priority Data
Nov. 8, 2000 (KR) 2000/66169

(51) Int. Cl. G06F 17/60

(52) U.S. Cl. 705/1

(57) ABSTRACT

There is provided a method of electronic business transaction using hardware identification numbers, which includes a step 1 of extracting a hardware identification number from the hardware of a user computer, a step 2 of transmitting the extracted hardware identification number to a server; and a step 3 of generating an identification number account based on the transmitted hardware identification number in an identification number account database of the server, the database containing information about identification numbers of user computers, and confirming the existing identification number account with the transmitted identification number to use the identification number account as a user account when an identification number account having the same identification number as the transmitted identification number has already existed in the database. There is also provided an apparatus of electronic business transaction using hardware identification numbers, which includes a user computer having a program 1 for extracting the identification number of a hardware item contained in the computer to transmit it, and a server having a program 2 for generating an identification number based on the identification number, which corresponds to a conventional user account when the transmitted hardware identification number is a new one and performs a procedure of confirming an identification number account using the transmitted identification number to use the identification number account as a user account when the transmitted identification number is the one that has been already registered, and having further an identification number account database including information on the identification number account.

### BACKGROUND OF THE INVENTION

1. Field of the Invention

The present invention relates to a method and apparatus of electronic business transaction using inherent identification numbers of hardwares. Specifically, the invention relates to an apparatus of electronic business transaction including a user computer having a program that extracts the serial number of a modem or system board contained in the user computer or a hardware identification number such as media access control (MAC) address from a network card contained in the user computer to transmit it to a server that has a program generating an identification number account corresponding to a conventional user account, based on the identification number transmitted from the user computer when the identification number is a new one but accomplishing an identification number account confirmation procedure using the identification number when the transmitted identification number is the one that has been previously registered to use the identification number account as a user account. The invention also relates to a method of business transaction using the identification numbers of hardwares, which includes a step of extracting the identification number of hardware of the user computer, a step of transmitting the extracted identification number to the server, and a step of generating an identification number account corresponding to a conventional user account according to the identification number in case of a new one on the basis of the identification number transmitted but completing the identification number account confirmation procedure using the identification number to use the identification number account as a user account when the identification number is the one that has been previously registered.

2. Description of the Related Art

With the development of Internet networks and activation of electronic business, people increasingly connect to the networks and a single user generates multiple accounts of various web sites to access them in many cases. Although a user can use the same user ID for accessing many different sites, he has to use different user IDs when there has already existed the same ID as that he wants in a site he wants to register, or he wants to use different IDs for different web sites. In this case, the user has a difficulty in management of his IDs and passwords. To lessen this difficulty, a certain web site forms questions to which only the user who forgot his password can answer correctly and separately stores them to provide service for allowing users to confirm their forgotten passwords or user accounts. Furthermore, there are being generated portal sites or hub sites through which a user can connect to various web sites with a single access such that the user does not need to input his ID and password whenever he accesses each of many different sites. In other words, the user thinks it trouble to input his ID and password whenever he accesses a web site while he navigates various sites.

The user should input his personal information to attain his account in a specific web site. This may cause leakage of personal information. Accordingly, there is generated a case where a user who does not want to expose his personal information registers for a service site using a pseudonym to access it although the service site requires personal information of people for registration and access.

To solve the above problem, accordingly, there is needed a system and method for registering an account using the identification number of hardware on the basis of hardware to be capable of accessing a corresponding web site and registering the account for the service site, without requiring personal information.

People have their own computers with the rapid spread of personal computer, and network devices or system boards contained in the computers have their identification MAC addresses or serial numbers. Accordingly, the identification number of computer hardware of each user is assigned to a user account, without using the user account attained by the conventional registration procedure, to be used as an ID for confirming the user who attempts to access.

### SUMMARY OF THE INVENTION

It is, therefore, an object of the present invention to provide an apparatus of electronic business transaction using the identification numbers of hardwares instead of user information.

It is another object of the present invention to provide a method of electronic business transaction using the identification numbers of hardwares instead of user information.

To accomplish the first object of the present invention, there is provided an apparatus of electronic business transaction including a user computer having a program that extracts the serial number of a modem or system board contained in the user computer or a hardware identification number such as MAC address from a network card contained in the user computer to transmit it to a server and the server having a program generating an identification number account corresponding to a conventional user account based on the identification number transmitted from the user computer when the identification number is a new one but accomplishing an identification number account confirmation procedure using the identification number when the transmitted identification number is the one that has been previously registered to use the identification number account as a user account.

The program for extracting the hardware identification number, stored in the user computer, can be stored in the server. In this case, the user computer connects to the server to execute the program, and the hardware identification number extracted by the program is directly transmitted to the server.

To accomplish the second object of the present invention, there is also provided a method of electronic business transaction using the identification numbers of hardwares, which includes a step of extracting the identification number of hardware of the user computer, a step of transmitting the extracted identification number to the server, and a step of generating an identification number account corresponding to a conventional user account according to the identification number in case of a new user on the basis of the identification number transmitted but completing the identification number account confirmation procedure using the identification number to use the identification number account as a user account when the identification number is the one that has been previously registered.

### BRIEF DESCRIPTION OF THE DRAWINGS

FIG. 1 illustrates an embodiment of an apparatus of business transaction using hardware identification numbers according to the present invention;

FIG. 2 is a flow chart diagram showing a procedure of searching and registering a user account using a hardware identification number according to the present invention;

FIG. 3 illustrates an embodiment of an advertisement transfer web browser screen using a hardware identification number according to the present invention;

FIG. 4 is a flow chart diagram showing accumulation of advertisement points using a hardware identification number according to the present invention;

FIG. 5 illustrates an embodiment of free utilization of a charged site using a hardware identification number according to the present invention;

FIG. 6 is a flow chart diagram showing free utilization of a charged site using a hardware identification number according to the present invention;

FIG. 7 illustrates an embodiment of management of accumulated points using a hardware identification number according to the present invention; and

FIG. 8 is a flow chart diagram showing management of a charged site account using a hardware identification number according to the present invention.

### DETAILED DESCRIPTION OF THE PREFERRED EMBODIMENT

Reference will now be made in detail to the preferred embodiments of the present invention, examples of which are illustrated in the accompanying drawings.

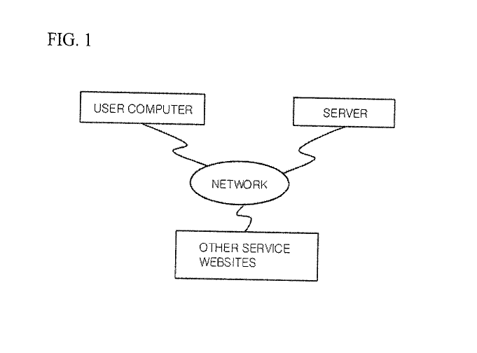

FIG. 1 illustrates an embodiment of an apparatus of business transaction using hardware identification numbers of the present invention. Referring to FIG. 1, the system of the present invention includes a user computer having a network interface through which a user can connect with a server, a network connecting the user computer with the server, and the server having a user account database, which is connected to the network. The user computer has a hard disk that stores a program for extracting the identification number of hardware of the user computer and a central processing unit that executes the program.

The hardware identification number may be a media access control (MAC) address in case of a network card and a serial number in case of a modem or system board. Actually the hardware identification number is stored in a storage place of the hardware, the place being accessible by software, so that it can be extracted by the program to be transmitted to the server.

The server registers the hardware identification number transmitted thereto from the user computer as a new identification number account in a user database thereof to generate an identification number account based on the identification number in an identification number account database thereof when the transmitted hardware identification number does not exist in an identification number database previously stored in the server. If the identification number exists in the identification number database, which means the user who owns the computer hardware with the identification number has the identification number account already registered, the server confirms if the identification number corresponds to the identification number in the identification number account database to authenticate the identification number account and allows the identification number to be used as the identification number account. Furthermore, the user can be connected with multiple cooperation sites or Internet networks which have the server as a hub site or portal site using his identification number account.

The program for extracting the hardware identification number, stored in the user computer, may be stored in the server. The user can execute the program stored in the server by accessing the server through the user computer. Specifically, the hardware identification number of the user computer is extracted by using a method similar to the method of finding out the MAC address of a counterpart through address resolution protocol (ARP) in TCP/IP protocol, and the extracted hardware identification number is directly compared with the identification number account database in the server to be registered or authenticated as an account.

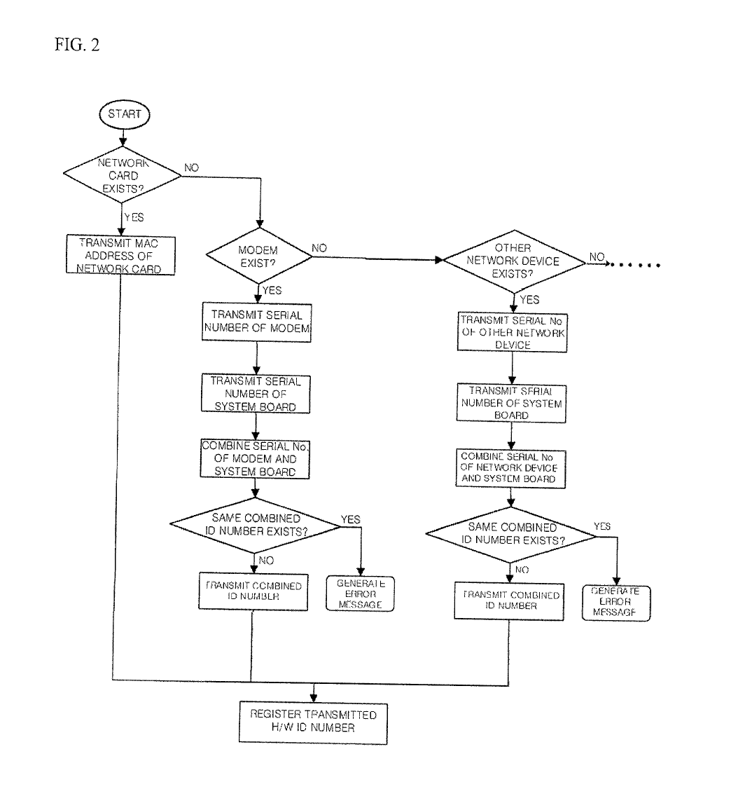

FIG. 2 is a flow chart diagram showing user account search and registration using the hardware identification number as a new account according to the present invention. In registration and authentication of an identification number account using the hardware identification number, the hardware identification number is used as the account name so that multiple identification number accounts having the same identification number may generate. To prevent this, there is required a procedure of confirming the registration of an identification number account. FIG. 2 shows an embodiment of this procedure.

The user computer must be connected to the network so that a network interface is necessarily required. Referring to FIG. 2, first of all, it is confirmed if a network card exists in the user computer. When it does, the MAC address of the network card is designated as a user account, completing registration of the user account. The MAC address of the network card is configured of 6-byte according to the international standard, having the form of 00:00:00:ab:cd:ef, for example, former 3-byte being a value assigned to a vendor and the latter 3-byte being a value assigned by the vendor. That is, the MAC address is determined by the vendor when the network card is manufactured, being produced together with the manufacture. This means that all of the network cards have different MAC address numbers. Accordingly, the user computer containing a specific network card has a specific network card's MAC address so that the MAC address can be used as an identification number account characterizing the user computer.

In case of a modem, the serial number of a modem registered first and the serial number of a modem to be registered later may collide with each other to generate a problem that the user computer including the modem to be registered later is recognized as a user already registered because there is no arranged serial number system in the modems. Accordingly, the serial number of the system board of the user computer as well as the serial number of the modem are read together to be combined with each other and this combined number is compared with the identification number account database, to be registered as an identification number account when there is no number that accords therewith. When there is, an error message is generated.

When the identification number account is registered using the combined serial number, the serial number of the modem and the serial number of the system board can be separately processed. That is, the serial numbers read from the hardware items are classified by adding identifiers thereto by the kinds of the hardware items or they are stored in databases being divided to be classified by the hardware items (modem, system board, etc.).

When the user computer has a network device other than the modem and network card, the serial number of the network device contained in the user computer and the serial number of the system board are searched and they are combined with each other to generate an identification number account, which is the same as the method performed for the modem.

The method shown in FIG. 2 is one of embodiments of registration of the identification number account using the hardware identification number. Another method is to generate a single identification number account with all the available hardware identification numbers without sequentially judging the hardware items contained in the user computer as described above. Specifically, the identification number account can be constructed in the form of a combination of the network card's MAC address, the modem's serial number, the system board's serial number and the other network device's serial number. In case that there is the network card contained in the user computer, the serial numbers of the modem and network card are represented as blanks or specific characters at a corresponding portion of the identification number account, and the serial number of the system board is inputted to the corresponding position in the identification number account since the system board always exists in the user computer. This method creates a problem that the length of the entire identification number account becomes too long. Accordingly, there can be applied a method of respectively giving identifiers to hardware items from which identification numbers are extracted, setting an identification number combined with the identifier for each hardware in the form of combination of the identifier and identification number, and generating an identification number account with the identification number combined with the identifier of the hardware that is actually contained in the user computer.

The present invention provides a method of electronic business transaction using the aforementioned system, which includes a step of extracting the identification number from the hardware of the user computer, a step of transmitting the extracted identification number to the server, and a step of, when the identification number is a new one, generating an identification number account corresponding to a conventional user account based on the identification number and, when the transmitted identification number is the one that has been already registered, accomplishing the identification number account confirmation procedure using the identification number to use the identification number account as a user account.

When the user account based on the hardware is registered as a new identification number account in the server or authentication of the previously registered identification number account is made according to the above method, all services from the server or cooperation sites connected to the server can be provided to the user in the same manner as that of the general portal site or hub site.

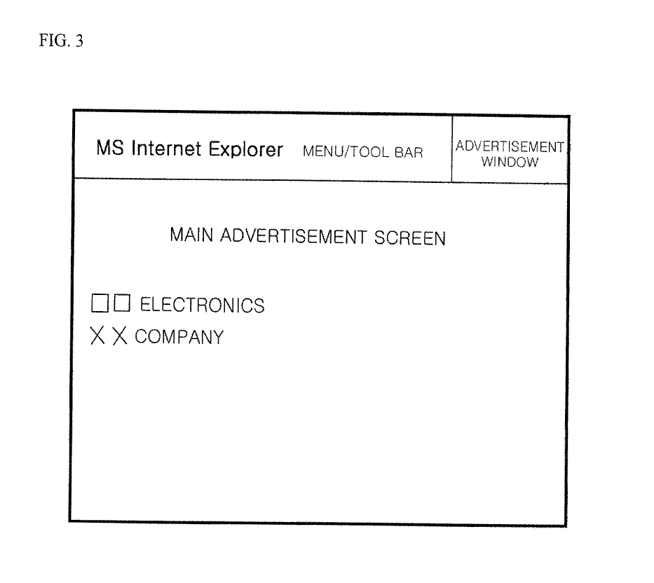

FIG. 3 illustrates an embodiment of an advertisement transfer web browser screen using the hardware identification number according to the present invention. A program in the form of a web browser can be used as the program for extracting the hardware identification number from the user computer to transmit it to the server. The user initially accesses the server using the user computer, downloads a web browser installation program from the server and installs it in the user computer. When the user connects with the server through the web browser, the web browser extracts the hardware identification number of the user computer to send it to the server through the program for transmitting the extracted identification number to the server. Accordingly, the user computer can automatically connect with sites in the server through the web browser without providing user information or having log-in procedure.

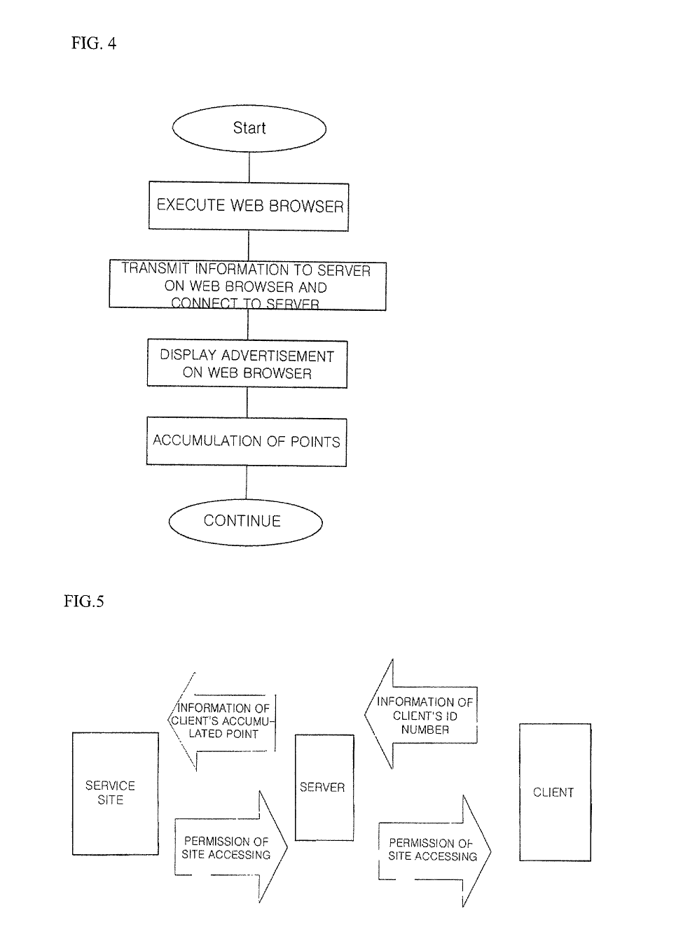

In addition, the web browser can further include an advertisement offer frame to provide advertisement accumulation point service that is the same as the conventional service of accumulating points when a user watches advertisements on the web browser. Here, the accumulated points are saved up in the identification number account established using the hardware identification number. This procedure is shown in FIG. 4. FIG. 4 is a flow chart diagram showing accumulation of advertisement points using the hardware identification number according to the present invention. This point accumulation can be made in case of purchase of goods, joining in events, participation in inquiries, etc. in addition to the watching advertisements. The manager of the server receives charges from advertisers for providing advertisements and points to users.

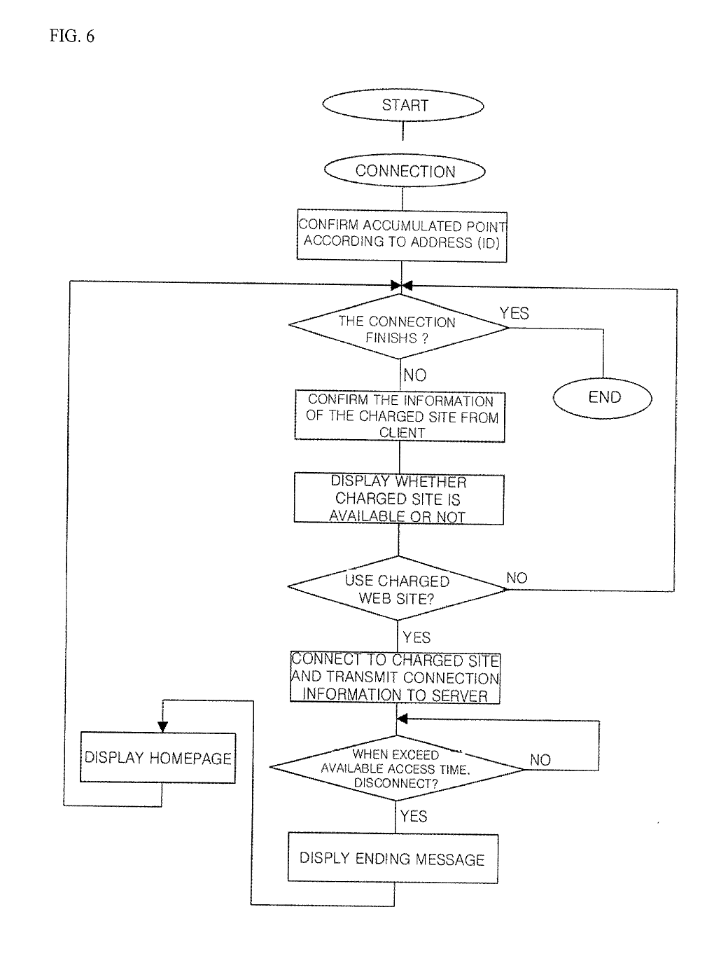

FIG. 5 illustrates an embodiment of free utilization of a charged site using the hardware identification number according to the present invention, in which points accumulated by watching advertisements are used for using a charged site. Specifically, when a user attempts to access the charged site on the web browser, the server confirms if the user deserves to use the charged site on the basis of the accumulated points of the identification number account confirmed by recognizing the hardware identification number. In case that there are sufficient accumulated points required for using the charged site, the user can connect with the charged site and the charged site provides service the user selects to him. The server deducts a part of the points, corresponding to the service the user used, from the total points to adjust the accumulated points of the identification number account. The server manager pays the charged site a charge for the service provided by it. This procedure is shown in FIG. 6. FIG. 6 is a flow chart diagram showing free utilization of a charged site using the hardware identification number according to the present invention.

Referring to FIG. 6, the user computer is connected to the server through the identification number account confirmed using the hardware identification number, and accumulated points with respect to the hardware identification number is confirmed in the identification number account of the server. When the user of the user computer connected to the server attempts to access the charged site, the server inquires accumulated points, required for the user computer to connect with the charged site, from a database with respect to the charged site stored therein, compares the required accumulated points with the accumulated points of the hardware identification number, determines if the user computer deserves to use the charged site, and displays it. Then, the server inquires of the user if he wants to use the charged site, and connects the user computer to the charged site when the user wants to do it to transmit service information to the server. When the period of time during which the user used the service of the charged site exceeds a predetermined available utilization time, or the user wants to finish the connection with the site, the connection between the user computer and the charged site is ended. Then, the server adjusts the accumulated points of the user account with respect to the hardware identification number on the basis of the charged site utilization time. The charge for the service of the charged site can be paid through a program stored in the server or by inputting by the server manager. A conventional method of using a charged site according to accumulated points by using a user account established based on user information can be also applied as the method of utilizing the charged site on the basis of the accumulated points if the conventional method changes its account management method.

Moreover, the accumulated points can be also used for purchasing goods on a shopping mall site.

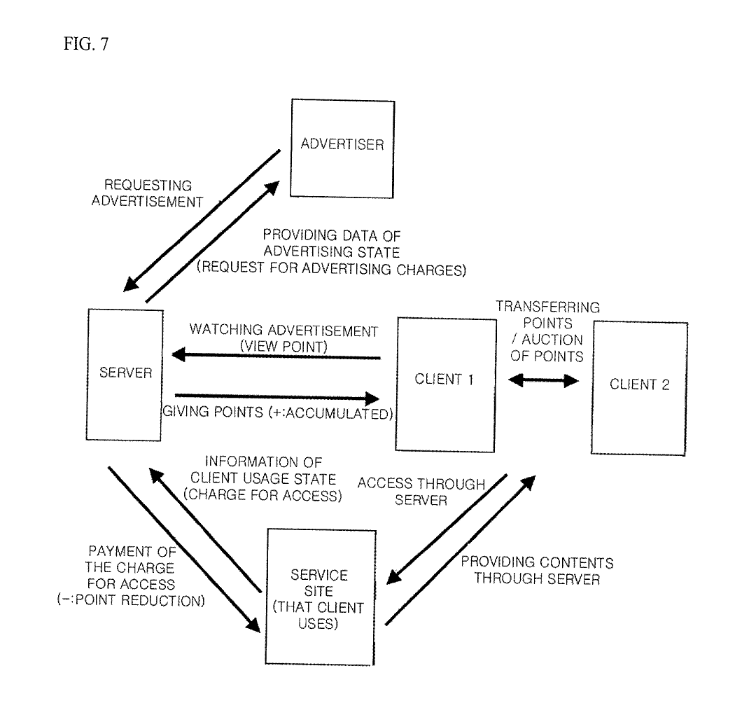

FIG. 7 illustrates an embodiment of management of the accumulated point using the hardware identification number according to the present invention. As described above, the points accumulated in the hardware identification number account by watching advertisements can be used for accessing the charged site, as shown in FIGS. 5 and 6. In addition to this, the accumulated points can be transferred between hardware identification number accounts, between a hardware identification number account and a conventional user account, or between conventional user accounts, which is a service provided by the server. Furthermore, the accumulated points can be sold or purchased by auction, and used for purchasing goods.

Furthermore, a user who wants to attain his account on a specific service site without exposing his personal information or who does not want to perform log-in procedure whenever accessing a specific service site can ask and use accounts of various service sites using his hardware identification number according to the present invention.

Specifically, the user accesses the server using his hardware identification number according to the present invention, and selects a service site provided by the server. The server confirms if registration information with respect to the service site exists in the identification number account of the user computer in the identification number account database stored therein and, when the registration information exists, connects with the service site using the registration information to connect the user computer to the service site. On the other hand, when the registration information does not exist in the identification number account, the server asks an account of the service site. Here, the service site makes a cooperative contract with the server to register a predetermined number of user accounts managed by the server without accepting personal information of users. Thus, the service site generates the account at the server's request and informs the server of it. Then, the server additionally stores and connects the registration account of the service site to the identification number account of the user computer that selects the service site in the identification number account database, informs the user computer that the account of the service site is opened and provides services to the user computer.

Upon generation of the account of the service site and change in the content of the identification number account database, the user computer can access the service site using the registration information in the identification number account database whose content is changed of the server.

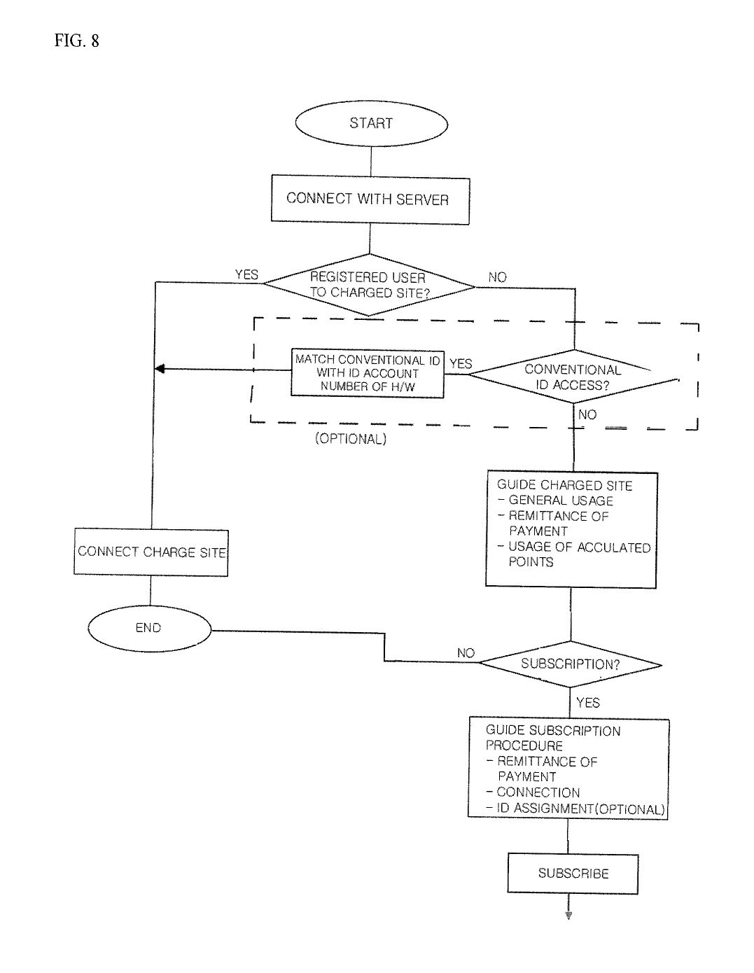

In case of the charged site, especially, the user can connect the site only when he has paid a charge for using it. This requires a separate process. FIG. 8 is a flow chart diagram showing a procedure of managing the account of the charged site using the hardware identification number according to the present invention. In the method of attaining the account of a service site without exposing personal information, when the service site is a charged site, the user accesses the server using his hardware identification number and selects the charged site provided by the server. The server confirms if registration information with respect to the charged site exists in the identification number account of the user computer in the identification number account database stored therein and, when the registration information exists, connects with the charged site using the registration information to connect the user computer to the charged site. On the other hand, when the registration information does not exist in the identification number account, the server requests the user to input a pseudonymous account name or temporary account name and to pay a charge for using the charged site, and ask the account of the charged site when the user did it. Here, the charged site makes a cooperative contract with the server to register a predetermined number of user accounts managed by the server without accepting personal information of users. Thus, the charged site generates the account at the server's request and informs the server of it. Then, the server additionally stores and connects the registration account of the charged site to the identification number account of the user computer that selects the charged site of the identification number account database, informs the user computer that the account of the charged site has been opened and provides services to the user.

The account of the charged site may use the pseudonymous account name or temporary account name initially inputted by the user or a name arbitrarily provided by the server or the charged site as its name. The pseudonymous account name or temporary account name inputted by the user and the arbitrary account name provided by the server or charged site are stored in the identification number account database of the server by identification number accounts.

According to opening a new account in the charged site and changing the content of the identification number account database, the user computer can directly connect to the charged site using the charged site registration information of the identification number account in the identification number account database of the server. Furthermore, the user can access the charge site through the pseudonymous account name, temporary account name or arbitrary account name provided by the server or the charged site using the identification number account database changed by identification number accounts. That is, when the user has registered at the charged site and then connects thereto using the pseudonymous account name, temporary account name or arbitrary account name provided by the server or the charged site, the account name inputted by the user who accessed the site is compared with the pseudonymous account name, temporary account name or arbitrary account name provided by the server or the charged site, which are registered in the identification number account database of the service by the identification number accounts, to allow the user to connect to the charged site when they accord with each other.

Moreover, though the user can pay a charge for using the charge site by money in registration of the new account of the charged site, he can pay a part or all parts of the charge using the points accumulated on his identification number account through watching advertisements, answering to inquiries, etc.

As described above, according to the apparatus and method of electronic business transaction using hardware identification numbers of hardwares of the present invention, a user can connect to a web site using his account registered using the identification number of his computer hardware without providing his personal information. In addition, it is possible to solve the aforementioned prior art problem that the user has a difficulty in management of his IDs and passwords when he opens accounts of multiple sites using different user IDs. Moreover, the user can be protected from exposing his personal information, and he does not need to input his ID and password whenever he accesses web sites. This reduces a period of time required for the access.

What is claimed is:

1. A method of electronic business transaction using identification numbers of hardwares, comprising:
a step 1 of extracting a hardware identification number from the hardware of a user computer;
a step 2 of transmitting the extracted hardware identification number to a server; and
a step 3 of generating an identification number account based on the transmitted hardware identification number in an identification number account database of the server, the database containing information about identification numbers of user computers, and confirming the existing identification number account with the transmitted identification number to use the identification number account as a user account when an identification number account having the same identification number as the transmitted identification number has already existed in the database.

2. The method as claimed in claim 1, wherein the hardware identification number corresponds to at least one of a network card's MAC address, a modem's serial number, other network devices' serial numbers and a system board's serial number.

3. The method as claimed in claim 2, wherein, in generation of the identification number account at the step 3, the identification number account is created with the MAC address when the hardware identification number transmitted to the server is the MAC address, the serial numbers of the modem and the system board are combined to generate the identification number account in the identification number account database when the hardware identification number transmitted to the server is the serial number of the modem, and the serial numbers of the network device and the system board are combined to generate the identification number account in the identification number account database when the hardware identification number transmitted to the server is the serial number of the network device.

4. The method as claimed in claim 2, wherein, in generation of the identification number account at the step 3, the identification number account is created using a combination of at least two of the network card's MAC address, the modem's serial number, the system board's serial number and the network device's serial number.

5. The method as claimed in any one of claims 1 to 4, further comprising the steps of:
selecting a service site provided by the server;
confirming if registration information with respect to the service site exists in the identification number account of the user computer from the identification number account database therein; and
connecting to the service site using the registration information to connect the user computer to the service site when the information exists in the identification number account and asking and generating an account of the service site, additionally storing the registration account of the service site in the corresponding identification number account of the identification number account database to renew account registration information, and connecting to the service site when the information does not exist.

6. The method as claimed in any one of claims 1 to 4, further comprising the steps of:
selecting a charged site provided by the server;
confirming if registration information with respect to the charged site exists in the identification number account of the user computer from the identification number account database therein; and
connecting to the service site using the registration information to connect the user computer to the charged site when the information exists in the identification number account and requesting the user to input a temporary account name and to pay a charge for using the site to the charged site, asking and generating an account of the charged site after the user inputs the temporary account name and pays the charge, additionally storing the registration account of the charged site in the corresponding identification number account of the identification number account database to renew account registration information, and connecting to the charged site when the information does not exist.

7. The method as claimed in claim 6, wherein a part or all parts of the charge for using the charged site is paid using accumulated points of the account.

8. The method as claimed in any one of claims 1 to 4, further comprising a point accumulation step at which an advertisement display site provides service through the user account, and points with respect to the services are accumulated on the user account based on the hardware identification number.

9. The method as claimed in claim 8, wherein the service corresponds to at least one of watching advertisements, answering to inquiries and purchasing goods.

10. The method as claimed in claim 8, further comprising a step of connecting to a charged site using the accumulated points and paying a charge to the site for using it by using the accumulated points.

11. The method as claimed in claim 8, further comprising a step of purchasing goods on a shopping mall site using the accumulated points and paying for the goods using the accumulated points.

12. The method as claimed in claim 8, further comprising a step of exchanging, transferring, buying and selling or auctioning the accumulated points between users.

13. An apparatus of electronic business transaction using identification numbers of hardwares, comprising:
a user computer having a program 1 for extracting the identification number of a hardware item contained in the computer to transmit it; and
a server having a program 2 for generating an identification number based on the identification number, which corresponds to a conventional user account, when the transmitted hardware identification number is a new one performs a procedure of confirming an identification number account using the transmitted identification number to use the identification number account as a user account and when the transmitted identification number is the one that has been already registered, and having an identification number account database including information on the identification number account.

14. The system as claimed in claim 13, wherein the program 1 is a web browser including an advertisement display.

15. An apparatus of electronic business transaction using identification numbers of hardwares, comprising:
a user computer (client); and
a server having a program for extracting the identification number of a hardware item contained in the computer to transmit it, a program for generating an identification number account based on the identification number, which corresponds to a conventional user account, when the transmitted hardware identification number is a new one and performs a procedure of confirming an identification number account using the identification number to use the identification number account as a user account when the transmitted identification number is the one that has been already registered, and an identification number account database including information on the identification number account.
